(19) United States
(12) Patent Application Publication
(10) Pub. No.: US 2025/0202873 A1
(43) Pub. Date: Jun. 19, 2025

(54) FAST PRE-SORTED SECURITY LOGGING FOR OPEN-RADIO ACCESS NETWORKS (O-RANS)

(71) Applicant: Fujitsu Limited, Kawasaki-shi (JP)

(72) Inventor: Shahriar EMAMI, Newark, CA (US)

(73) Assignee: Fujitsu Limited, Kawasaki-shi (JP)

(21) Appl. No.: 18/544,742

(22) Filed: Dec. 19, 2023

(51) Int. Cl. H04L 9/40; H04W 12/03

(52) U.S. Cl. CPC H04L 63/06; H04L 63/0263; H04W 12/03

(57) ABSTRACT

In an embodiment, operations include detecting a first event log associated with a first network component of an open-radio access network (O-RAN). The operations further include generating a first digest. The operations further include generating each encryption key of a first set of encryption keys, based on an encryption layer of a set of encryption layers, and the first event log. The operations further include generating a first set of encrypted digests for the first digest. The operations further include generating first log information associated with the first network component. The operations further include transmitting the first log information to a service management component of the O-RAN. The service management component is configured to pre-sort the first log information, based on the first set of encrypted digests. The operations further include controlling a first display device to render the first log information.

### FIELD

The embodiments discussed in the present disclosure are related to fast pre-sorted security logging for open-radio access networks (O-RANS).

### BACKGROUND

Advancements and evolution in networking and telecommunication systems have led to emergence of open-radio access network (O-RAN) technology that facilitates decentralization of network infrastructure and introduces interoperability between network components associated with different vendors. The decentralization may be actualized based on virtualization of integrated legacy radio access networks into open, modular, and interoperable components. The virtualization may involve disaggregation of the legacy radio access networks based on functionality such that disaggregated components (such as radio units, distributed units, or centralized units) of a virtual radio access network may be managed using intelligent controllers and connected to each other via standardized open interfaces. The disaggregation may facilitate adoption of innovation, optimization, and development in both hardware and software associated with components of a fifth generation (5G) network and building a 5G network with a greater flexibility and scalability compared to a proprietary 5G radio access network. The disaggregated radio access networks (i.e., ORANs) may enable actualization of cost-effective network deployment in small cells and improve network efficiency.

However, network disaggregation, usage of open-interfaces, and adoption of non-proprietary solutions may pose unprecedented challenges in ensuring security and countering threats/attacks on the O-RAN components and user data that may be stored in the O-RAN. The attacks may compromise availability of O-RAN infrastructure, which may be due to an unauthorized access to one or more disaggregated O-RAN components or insertion of inauthentic logs in depositories associated with the disaggregated O-RAN components. Such attacks may degrade or deteriorate performance of the O-RAN.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include a set of operations, which may include detecting a first event log associated with a first network component of an open-radio access network (O-RAN). The operations may further include generation of a first digest associated with the first event log. The operations may further include generation of a first set of encryption keys associated with each layer of a set of layers for the first digest, based on the first event log. The operations may further include generation of a first set of encrypted digests for the first digest, based on the first set of encryption keys associated with each layer of the set of layers for the first digest. The operations may further include generation of first log information associated with the first network component, based on the first event log and the first set of encrypted digests. The operations may further include transmission of the first log information to a service management component of the O-RAN. The service management component may be configured to pre-sort the first log information into the first event log, based on the first set of encrypted digests. The operations may further include controlling a first display device to render the first log information.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example network environment related to fast pre-sorted security logging for open-radio access networks (O-RANS);

FIG. 2 is a block diagram that illustrates an exemplary electronic device for fast pre-sorted security logging for open-radio access networks (O-RANS);

FIG. 3 is a diagram that illustrates an exemplary execution pipeline for facilitating fast pre-sorted security logging for open-radio access networks (O-RANS);

FIG. 4 is a diagram that illustrates an exemplary execution pipeline for keys determination;

FIG. 5 is a diagram that illustrates an exemplary architecture of an O-RAN;

FIG. 6A is a diagram that illustrates an exemplary scenario for determination of a set of encryption keys;

FIG. 6B is a diagram that illustrates an exemplary scenario for determination of a first set of encryption keys based on an application of an encoder model;

FIG. 7A is a diagram that illustrates an exemplary scenario for generation of a first set of encrypted digests;

FIG. 7B is a diagram that illustrates an exemplary scenario first log information; and

FIG. 8 is a diagram that illustrates a flowchart of an example method for fast pre-sorted security logging for open-radio access networks (O-RANS);

all according to at least one embodiment described in the present disclosure.

### DESCRIPTION OF EMBODIMENTS

Some embodiments described in the present disclosure relate to methods and systems for fast pre-sorted security logging for open-radio access networks (O-RANS). Herein, a first event log associated with a first network component of an open-radio access network (O-RAN) is detected. Thereafter, a first digest associated with the first event log may be generated. A first set of encryption keys associated with each layer of a set of layers for the first digest may be generated based on the first event log. Based on the first set of encryption keys associated with each layer of the set of layers for the first digest, a first set of encrypted digests for the first digest, may be generated. Based on the first event log and the first set of encrypted digests, first log information associated with the first network component may be generated. The first log information may be transmitted to a service management component of the O-RAN. The service management component may be configured to pre-sort the first log information into the first event log, based on the first set of encrypted digests. A first display device may be controlled to render the first log information.

An O-RAN architecture may be a distributed network architecture that may include disaggregated radio access network components (for example, distributed units, centralized units, radio units, and so on). The network components of the O-RAN may be connected to each other via O-RAN open interfaces (for example, E2 interface, O1 interface, A1 interface, and so on). The open interfaces may be used to connect network components with controllers (such as, radio access network intelligent controllers) that may optimize, deploy control actions and policies, stream telemetry, and so on, via the open interfaces. Therefore, an O-RAN may support modularity and interoperability between hardware/software associated with the network components manufactured by different vendors. This may enable cloudification and virtualization of a legacy radio access network, simplify network management and maintenance, and reduce cost. The disaggregation of the radio access network components may enable creation of flexible and scalable networks that have greater agility and resiliency, are adaptive to innovations, and whose dependency on proprietary solutions is significantly reduced.

However, an O-RAN architecture may introduce significant security challenges for mobile network operators. The security challenges may be further enhanced due to vulnerability of attacks on the open interfaces, usage of non-proprietary solutions (hardware/software that may originate from multiple vendors), and so on. Some of the security challenges facing the deployment of O-RANs may include compromising of one or more of an integrity and confidentiality of user data, integrity of O-RAN infrastructure, or an availability of the O-RAN infrastructure. These attacks may take place due to unauthorized access to disaggregated radio access network, malicious deployment of applications, usage of compromised software, misconfiguration of the open interfaces, unregulated access to user data, and so on. Such an attack may degrade or deteriorate the overall performance of the O-RAN and lead to creation of conflict between applications. Typically, pre-sorting of first log information may require a distinct encryption key for each event type. Therefore, a number of encryption keys needed for pre-sorting may of a considerable number depending on a number of event types. A generation, delivery, removal, and maintenance of such number of encryption keys may be challenging.

According to one or more embodiments of the present disclosure, the technological field of security logging for O-RAN may be improved by using a fast pre-sorted security logging for O-RANs. The improvements of the security logging for O-RAN may be such that a computing system may detect the first event log associated with the first network component of the open-radio access network (O-RAN). Thereafter, the computing system may generate the first digest associated with the first event log. Based on the encryption layer of the set of encryption layers, and the first event log, the computing system may generate each encryption key of the first set of encryption keys. Based on the first set of encryption keys, the computing system may generate the first set of encrypted digests for the first digest. Based on the first event log and the first set of encrypted digests, the computing system may generate the first log information associated with the first network component. The computing system may transmit the first log information to a service management component of the O-RAN. The computing system may control the first display device to render the first log information.

The disclosed computing system may thus introduce a fast pre-sorted logging scheme capable of avoiding log content examination. The computing system may generate each encryption key of the first set of encryption keys based on the encryption layer of the set of encryption layers. With the proposed computing system, multiple encryption layers of encryption keys may establish a greater number of new encryption key combinations that may be generated in a structured fashion. In an example, for a given “M” number of encryption layers, where a first encryption layer may be associated with “N₁” number of encryption keys, a second encryption layer may be associated with “N₂” number of encryption keys, . . . , and an “M^{th}” encryption layer may be associated with “N_{M}” number of encryption keys then a total number of required encryption keys may be a summation of “N₁”, “N₂”, . . . , and “N_{M}”. A number of event types that may be supported may be a product of “N₁”, “N₂”, . . . , and “N_{M}”. For example, if a number of event types is assigned as “27”, then a typical approach may deploy “27” encryption keys. In case of the disclosed computing device, a 3-layered encryption key scheme may be used with “3” encryption keys per layer. Further, the traditional approach may require “14” verifications for the “27” event types, however, in case of the disclosed computing device, only “6” verifications may be sufficient. Therefore, the disclosed computing system may provide pre-sorted security logging capability for O-RANs based on a layered encryption key scheme. The disclosed technique may require a lesser number of total of encryption keys (by use of a layered encryption scheme) for a given number of event types. Further, a number of verifications required may be also lowered.

Embodiments of the present disclosure are explained with reference to the accompanying drawings.

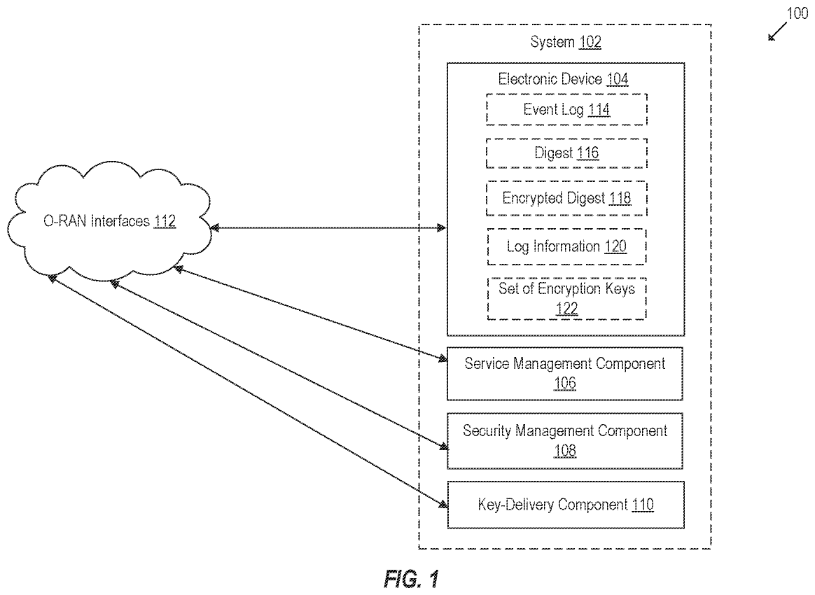

FIG. 1 is a diagram representing an example network environment related to fast pre-sorted security logging for open-radio access networks (O-RANS), according to at least one embodiment described in the present disclosure. With reference to FIG. 1, there is shown a network environment 100. The network environment 100 may include a system 102 that may include a portion of an O-RAN. The system 102 may include disaggregated radio access network components, such as, an electronic device 104, a service management component 106, a security management component 108, and a key-delivery component 110. The electronic device 104, the service management component 106, the security management component 108, the key-delivery component 110, and other network components (not shown) of the O-RAN may be coupled to each other communicatively, via O-RAN interfaces 112. In FIG. 1, there is further shown, an event log 114, a digest 116, an encrypted digest 118, log information 120, and a set of encryption keys 122 associated with the electronic device 104.

The electronic device 104 may include suitable logic, circuitry, interfaces, and/or code that may be configured to detect a first event log (for example, the event log 114) associated with a network component (i.e., the electronic device 104) of an O-RAN (i.e., the system 102). Further, the electronic device 104 may generate a first digest (for example, the digest 116) associated with the first event log (for example, the event log 114). Further, the electronic device 104 may generate each encryption key of a first set of encryption keys (for example, the set of encryption key 122), based on an encryption layer of a set of encryption layers, and the first event log (for example, the event log 114). The electronic device 104 may generate a first set of encrypted digests (for example, the encrypted digest 118) for the first digest (for example, the digest 116), based on the first set of encryption keys (for example, the set of encryption keys 122). The electronic device 104 may generate first log information (for example, the log information 120) associated with the first network component, based on the first event log (for example, the event log 114) and the first set of encrypted digests (for example, the encrypted digest 118). The electronic device 104 may transmit the first log information (for example, the log information 120) to the service management component 106 of the O-RAN, the service management component 106 may be configured to pre-sort the first log information (for example, the log information 120), based on the first set of encrypted digests (for example, the encrypted digest 118). The electronic device 104 may control a first display device to render the first log information (for example, the log information 120). Examples of the electronic device 104 (i.e., the network component) may include, but may not be limited to, an open-cloud (O-Cloud) component, a radio unit (RU) component, a distributed unit (DU) component, a centralized unit (CU) component, or a near real-time radio intelligent controller (near-RT RIC) component.

The O-Cloud may correspond to a set of hardware and software components that may provide cloud computing capabilities for execution of radio access network functions. The software components may be coupled or decoupled from the hardware components as the software components and the hardware components may be sourced from same/different vendors. The O-Cloud may host one or more radio access network functionalities associated with the network components of the O-RAN. For example, the radio access network functionalities associated with each of the DU, CU-user plane (CU-UP), CU-control plane (CU-CP), near-RT RIC, and non-RT RIC components may be deployed over the O-Cloud as a software running on any commercially available off-the-shelf (COTS) hardware sourced from any vendor.

The RU may correspond to radio hardware that may covert radio signals, that may be received by or transmitted from antennas, into digital signals for transmission over packet-data networks. The RU may be configured to manage digital front end (DFE) and functionalities of the physical layer (i.e., layer-1 or L1). The RU may further manage digital beamforming functionality. The RU may be implemented on Field Programmable Gate Arrays (FPGAs) and Application-specific Integrated Circuits (ASICs). The RU may be deployed close to Radio Frequency (RF) antennas.

The DU may correspond to hardware, software, or a combination of hardware and software that may be configured to perform functionalities associated with medium access control (MAC) layer and radio link control (RLC) layer (i.e., real time layer-2 scheduling functions). The DU may further perform certain functionalities associated with physical layer (i.e., real time layer-1 scheduling functions). The DU may be hosted on on-site (i.e., along with the RU) on a COTS server or in an edge cloud (i.e., datacenter or central office) based on transport availability and fronthaul interface.

The CU may include two logical components, viz., the CU-CP and the CU-UP. The logical components, i.e., the CU-CP and the CU-UP, may be configured to perform different functionalities, associated with different hardware platforms, and deployed at different locations within the O-RAN (i.e., the system 102). For example, the CU-CP may manage control plane layers of the O-RAN, while the CU-UP may manage user plane layers of the O-RAN. The CU-CP and the CU-UP may perform non-real-time functionalities of radio resource control (RRC) layer, service data adaptation protocol (SDAP) layer and packet data convergence protocol (PDCP) layer. It may be noted that the CU may manage multiple DUs.

The near-RT RIC and non-RT RIC may be logical controllers that may run optimization routines with closed-loop control and orchestrate the O-RAN. The near-RT RIC and non-RT RIC may determine control policies and apply the determined control policies and actions on the network components of the O-RAN. The non-RT RIC may be included in the service management component 106 and influence operations of the service management component 106. The near-RT RIC may be deployed at the edge of the O-RAN (i.e., the system 102) and operate control loops with a certain periodicity. The near-RT RIC may interact with DUs and CUs in the O-RAN. The near-RT RIC may include multiple applications that support custom applications and services that may be required to support execution of the applications.

The service management component 106 may include suitable logic, circuitry, and interfaces, and/or code that may be configured to oversee orchestration aspects, management, and automation of the network components (such as the electronic device 104) of the O-RAN (i.e., the system 102). The service management component 106 may be further configured to support the O-RAN interfaces 112. In at least one embodiment, the service management component 106 may receive the first log information (for example, the log information 120) that may be transmitted by the electronic device 104 (i.e., a network component).

The security management component 108 may include suitable logic, circuitry, interfaces, and/or code that may be configured to perform log management, event correlation, incident monitoring, response generation, and so on. Examples of the security management component 108 may be a security information and event management (SIEM) that may be an amalgamation of security information management (SIM) and security event management (SEM) functions. The SIEM may facilitate real-time visibility and recognition of threats, centralization of log file data, troubleshooting, auditing, and compliance management.

The key-delivery component 110 may include suitable logic, circuitry, interfaces, and/or code that may be configured to store cryptographic keys associated with each of the network components (such as the electronic device 104) of the O-RAN. In at least one embodiment, each network component of the O-RAN may be associated with a unique cryptographic key. In some embodiments, all network components of the O-RAN may be associated with a single cryptographic key. The key-delivery component 110 may deliver the stored cryptographic keys to the electronic device 104 (and other network components), and the service management component 106. The key-delivery component 110 may function as a database that may be stored or cached on devices such as each of network components (including the electronic device 104) of the O-RAN and the service management component 106.

The O-RAN interfaces 112 may include a set of open interfaces via which network components (such as the electronic device 104) of the O-RAN (i.e., the system 102), the service management component 106, the security management component 108, and the key-delivery component 110, may communicate with each other. In at least one embodiment, the service management component 106, the security management component 108, and the key-delivery component 110 may be referred to as network components of the O-RAN. The set of open interfaces may include an E1 interface, an E2 interface, an A1 interface, an O1 interface, an O2 interface, and an open-fronthaul M-plane, and so on.

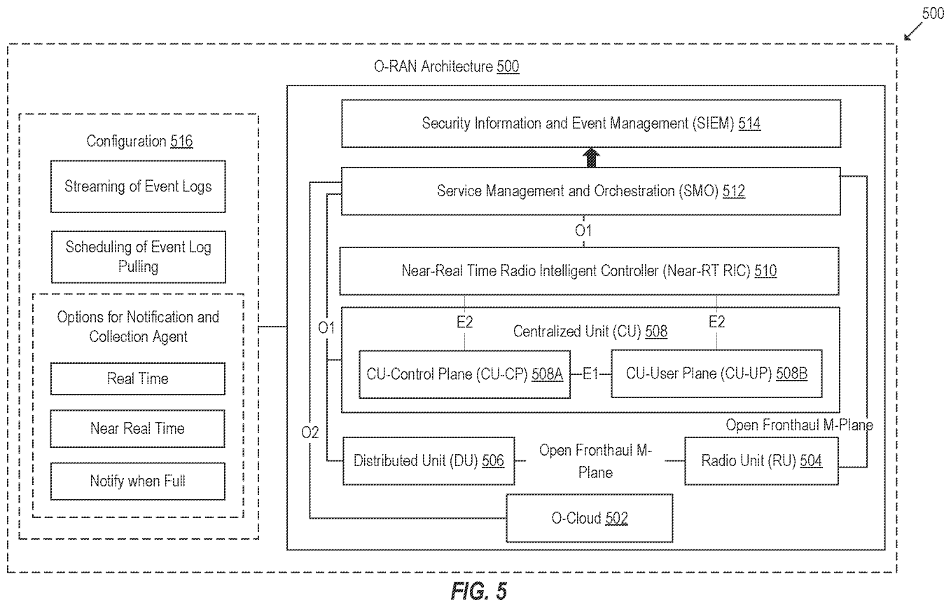

The E1 interface may connect the CU-CP and the CU-UP. The E2 interface may connect the near-RT RIC to the CU (i.e., the CU-CP and the CU-UP) and the DU. The E2 may enable streaming of telemetry, control instructions, and policies. The near-RT RIC may be connected to the non-RT RIC through the A1 interface. The non-RT RIC may be connected to other network components (i.e., RU, DU, CU, and near-RT RIC) of the O-RAN via the O1 interface. The O1 interface may enable management and orchestration of network functionalities. The non-RT RIC and the service management component 106 (SMO) may be connected to the O-Cloud through the O2 interface. The DU and RU may be connected to each other via the open-fronthaul M-plane. Details related to an exemplary architecture of the O-RAN are provided further, for example, in FIG. 5.

The electronic device 104 may include an encoder model (not shown in FIG. 1) may include suitable logic, circuitry, interfaces, and/or code that may be configured generate to the first set of encryption keys (e.g., the set of encryption keys 122) based on the set of encryption layers and the first digest (e.g., the digest 116). In an embodiment, the encoder model may be a classifier model which may be trained to identify a relationship between inputs, such as features in a training dataset and output labels. The encoder model may be defined by its hyper-parameters, for example, number of weights, cost function, input size, number of layers, and the like. The parameters of the encoder model may be tuned and weights may be updated so as to move towards a global minima of a cost function for the Encoder model. After several epochs of the training on the feature information in the training dataset, the Encoder model may be trained to output classification result or prediction result for a set of inputs.

The encoder model may include electronic data, which may be implemented as, for example, a software component of an application executable on the electronic device 104. The encoder model may rely on libraries, external scripts, or other logic/instructions for execution by a processing device. The encoder model may include code and routines configured to enable a computing device to perform one or more operations such as, generation of the set of encryption keys 122. Additionally or alternatively, the encoder model may be implemented using hardware including a processor, a microprocessor (e.g., to perform or control performance of one or more operations), a field-programmable gate array (FPGA), or an application-specific integrated circuit (ASIC). Alternatively, in some embodiments, the Encoder model may be implemented using a combination of hardware and software.

In an embodiment, the encoder model may be a neural network (NN) model. The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before, while training, or after training the neural network on a training dataset.

Each node of the neural network may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to same or a different same mathematical function.

In training of the neural network, one or more parameters of each node of the neural network may be updated based on whether an output of the final layer for a given input (from the training dataset) matches a correct result based on a loss function for the neural network. The above process may be repeated for same or a different input till a minima of loss function may be achieved, and a training error may be minimized. Several methods for training are known in art, for example, gradient descent, stochastic gradient descent, batch gradient descent, gradient boost, meta-heuristics, and the like.

The neural network may include electronic data, which may be implemented as, for example, a software component of an application executable on the electronic device 104. The neural network may rely on libraries, external scripts, or other logic/instructions for execution by a processing device. The neural network may include code and routines configured to enable a computing device to perform one or more operations for determination of the set of session slots. Additionally or alternatively, the neural network may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software.

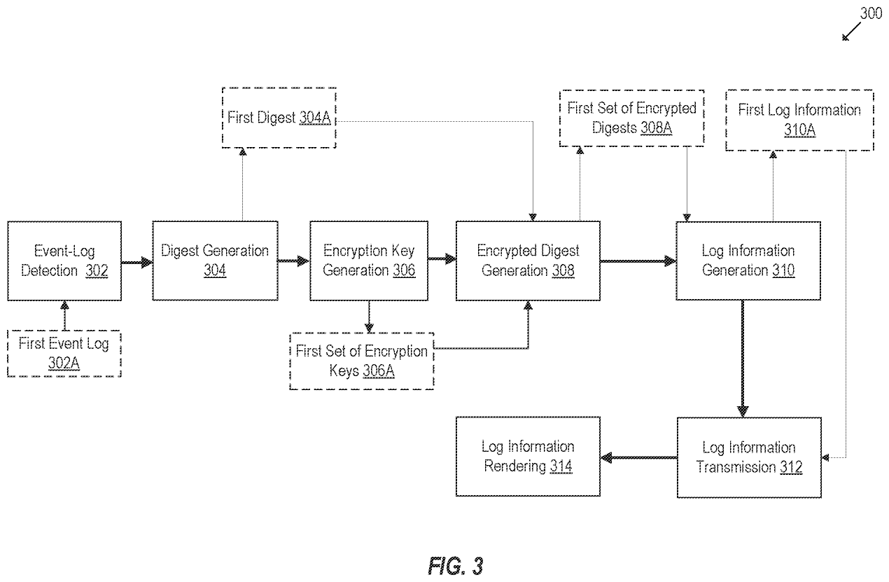

In operation, the electronic device 104 may be configured to detect the first event log (for example, the event log 114) associated with a network component (such as, a first network component) of an O-RAN (i.e., the system 102). The O-RAN may include a set of network components. The electronic device 104 may be the first network component of the set of network components included in the O-RAN (i.e., the system 102). The set of network components may include an O-cloud, a RU, a DU, a CU-CP, a CU-UP, or a near-RT RIC. The electronic device 104 (i.e., the first network component) may be one of the RU, the DU, the CU-CP, the CU-UP, or the near-RT RIC. The first event log (for example, the event log 114) may be detected based on an inclusion of the first event log (for example, the event log 114) on a depository of the electronic device 104. The detection of the first event log (for example, the event log 114) may be based on an occurrence of an event in the electronic device 104. Details related to event log detection are described further, for example, in FIG. 3 (at 302).

The electronic device 104 may be further configured to generate the first digest (for example, the digest 116) associated with the detected first event log (for example, the event log 114). The first digest (for example, the digest 116) associated with the first event log (for example, the event log 114) may be generated based on the detection of the first event log (for example, the event log 114). In accordance with an embodiment, the first digest (for example, the digest 116) may be a hash of the first event log (for example, the event log 114) that may be generated based on application of a digest generator on the first event log (for example, the event log 114). The digest generator may include a digest function that may generate the first digest (for example, the digest 116) as an output of the digest generator upon reception of the first event log (for example, the event log 114) as input. The output (i.e., the first digest (for example, the digest 116)) may be of a predefined size that may correspond to a summary of the first event log (for example, the event log 114). The output may function as an identifier of the first event log (for example, the event log 114). For example, the first digest (for example, the digest 116) may be a digest value that may be returned by the digest generator. Details related to digest generation are described further, for example, in FIG. 3 (at 304).

The electronic device 104 may be further configured to generate each encryption key of a first set of encryption keys (for example, the set of encryption keys 122), based on an encryption layer of a set of encryption layers, and the first event log (for example, the event log 114). In an embodiment, a number of encryption associated with each encryption layer of the first set of encryption keys (for example, the set of encryption keys 122) may be different. For example, a first encryption layer may be associated with “X” number of encryption keys, a second encryption layer may be associated with “Y” number of encryption keys, a third encryption layer may be associated with “Z” number of encryption keys. In an embodiment, a number of encryptions associated with each encryption layer of the first set of encryption keys (for example, the set of encryption keys 122) may be same. For example, each encryption layer may be associated with “X” number of encryption keys. Details related to encryption key generation are described further, for example, in FIG. 3 (at 306).

The electronic device 104 may be further configured to generate a first set of encrypted digests for the first digest (for example, the digest 116) based on the first set of encryption keys (for example, the set of encryption keys 122). Herein, each encryption key may be applied on the first digest (for example, the digest 116). Based on application of the encryption keys, the first set of encrypted digests may be generated. Details related to the generation of the first set of encrypted digests are further provided, for example, in FIG. 3 (at 308).

The electronic device 104 may be further configured to generate first log information (for example, the log information 120) associated with the network component (such as, the first network component). The generation of the first log information (for example, the log information 120) may be based on the first event log (for example, the event log 114) and the first set of encrypted digests (for example, the encrypted digest 118). In accordance with an embodiment, the first set of encrypted digests may be concatenated with the first event log (for example, the event log 114) for generation of the first log information (for example, the log information 120). Similarly, log information associated with each network component of the set of network components may be generated. Details related to log information generation are described further, for example, in FIG. 3 (at 310).

The electronic device 104 may be further configured to transmit the first log information (for example, the log information 120) to the service management component 106 (such as, the SMO) of the O-RAN (i.e., the system 102). The service management component 106 may be configured to pre-sort the first log information, based on the first set of encrypted digests. The service management component 106 may not have to analyze the contents of the first event log. The service management component 106 may pre-sort the first log information based on the first set of encrypted digests. Therefore, a time spent on analysis of contents of the first event log may be saved. Therefore, the electronic device 104 may enable an implementation of efficient, fast and tamper proof security logging solution. Details related to log information transmission are described further, for example, in FIG. 3 (at 312).

The electronic device 104 may be further configured to control a display device (such as a first display device associated with the electronic device 104 or the first network component) to render the first log information (for example, the log information 120). Similarly, the other network components of the set of network components may control display devices that are associated with corresponding network components. The display devices may be controlled for rendering of the log information associated with the other network components. Details related to log information rendering are described further, for example, in FIG. 3 (at 314).

Modifications, additions, or omissions may be made to FIG. 1 without departing from the scope of the disclosure. For example, the network environment 100 may include more or fewer elements than those illustrated and described in the present disclosure. In some embodiments, the functionality of each of the service management component 106 and the security management component 108 may be incorporated into one of the network components of the system 102, such as, the electronic device 104, without a deviation from the scope of the disclosure.

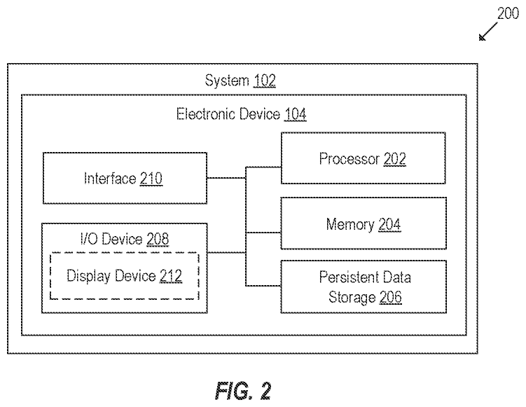

FIG. 2 is a block diagram that illustrates an exemplary electronic device for fast pre-sorted security logging for open-radio access networks (O-RANS), in accordance with at least one embodiment described in the present disclosure. FIG. 2 is explained in conjunction with elements from FIG. 1. With reference to FIG. 2, there is shown a block diagram 200 of the system 102, i.e., a portion of the O-RAN, that includes the electronic device 104 (i.e., the first network component). The electronic device 104 may include a processor 202, a memory 204, a persistent data storage 206, an input/output (I/O) device 208, and an interface 210. In at least one embodiment, the I/O device 208 may include a display device 212. It may be noted that each of the other network components of the O-RAN may include a processor, a memory, a persistent data storage, and an I/O device that includes a display device. The other network components are not shown and described in FIG. 2 for the sake of brevity.

The processor 202 may include suitable logic, circuitry, and interfaces that may be configured to execute a set of instructions stored in the memory 204. The processor 202 may be configured to execute program instructions associated with different operations to be executed by the electronic device 104. The processor 202 may be configured to detect the first event log (for example, the event log 114) associated with a first network component (i.e., the electronic device 104) of the O-RAN (i.e., the system 102). The processor 202 may be further configured to generate the first digest (for example, the digest 116) associated with the first event log (for example, the event log 114). The processor 202 may generate the first set of encrypted digests (for example, the encrypted digest 118) for the first digest (for example, the digest 116), based on the first set of encryption keys (for example, the set of encryption keys 122). The processor 202 may generate the first log information (for example, the log information 120) associated with the first network component, based on the first event log (for example, the event log 114) and the first set of encrypted digests (for example, the encrypted digest 118). The processor 202 may transmit the first log information (for example, the log information 120) to the service management component 106 of the O-RAN. The service management component 106 may be configured to pre-sort the first log information (for example, the log information 120), based on the first set of encrypted digests (for example, the encrypted digest 118). The processor 202 may control the first display device to render the first log information (for example, the log information 120).

The processor 202 may be implemented based on a number of processor technologies known in the art. Examples of the processor technologies may include, but are not limited to, a Central Processing Unit (CPU), X86-based processor, a Reduced Instruction Set Computing (RISC) processor, an Application-Specific Integrated Circuit (ASIC) processor, a Complex Instruction Set Computing (CISC) processor, a Graphical Processing Unit (GPU), a co-processor, or a combination thereof.

Although illustrated as a single processor in FIG. 2, the processor 202 may include any number of processors configured to, individually or collectively, perform or direct performance of any number of operations of the electronic device 104, as described in the present disclosure. Additionally, one or more of the processors may be present on one or more different electronic devices, such as different servers. In at least one embodiment, the processor 202 may be configured to interpret and/or execute program instructions, or process data that may be stored in the memory 204 or the persistent data storage 206. In some embodiments, the processor 202 be configured to may fetch program instructions from the persistent data storage 206 and load the program instructions in the memory 204. After the program instructions are loaded into the memory 204, the processor 202 may execute the program instructions.

The memory 204 may include suitable logic, circuitry, and interfaces that may be configured to store the one or more instructions to be executed by the processor 202. The one or more instructions stored in the memory 204 may be executed by the processor 202 to perform the different operations of the processor 202 (and the electronic device 104). The memory 204 may store the first event log (for example, the event log 114) associated with the first network component (i.e., the electronic device 104) of the O-RAN (i.e., the system 102), the first digest (for example, the digest 116) associated with the detected first event log (for example, the event log 114), the first set of encrypted digest (such as, the encrypted digest 118), the first log information (for example, the log information 120), and the first set of encryption keys (for example, the set of encryption keys 122). Examples of implementation of the memory 204 may include, but are not limited to, a CPU cache, a Hard Disk Drive (HDD), a Solid-State Drive (SSD), Random Access Memory (RAM), Read Only Memory (ROM), Electrically Erasable Programmable Read-Only Memory (EEPROM), and/or a Secure Digital (SD) card.

The persistent data storage 206 may include suitable logic, circuitry, and/or interfaces that may be configured to store program instructions executable by the processor 202. The persistent data storage 206 may include computer-readable storage media for carrying or having computer-executable instructions or data structures stored thereon. Such computer-readable storage media may include any available media that may be accessed by a general-purpose or special-purpose computer, such as the processor 202. By way of example, and not limitation, such computer-readable storage media may include tangible or non-transitory computer-readable storage media, or any other storage medium which may be used to carry or store particular program code in the form of computer-executable instructions or data structures, which may be accessed by a general-purpose or special-purpose computer. Computer-executable instructions may include, for example, instructions and data configured to cause the processor 202 to perform a certain operation or group of operations associated with the electronic device 104 or the first network component of the O-RAN (i.e., the system 102).

The I/O device 208 may include suitable logic, circuitry, and interfaces that may be configured to receive inputs and render outputs based on the received inputs. For example, the I/O device 208 may receive an input that may trigger detection of the first event log associated with the first network component (i.e., the electronic device 104). The I/O device 208 may further receive a user input indicative of instructions to control a first display device (such as the display device 212) to render the first log information (for example, the log information 120). The I/O device 208 may include various input and output devices, which may be configured to communicate with the processor 202. Examples of the I/O device 208 may include, but are not limited to, a touch screen, a keyboard, a mouse, a joystick, the display device 212, a microphone, and a speaker.

The interface 210 may include suitable logic, circuitry, and interfaces that may be configured to facilitate communication between the processor 202 (i.e., the electronic device 104 or the first network component of the O-RAN) and each of other network components of the O-RAN, the service management component 106 (i.e., the SMO), the security management component 108 (i.e., the SIEM), and the key-delivery component 110, via the O-RAN interfaces 112 (for example, the E1 interface, the E2 interface, the A1 interface, the O1 interface, the O2 interface, and the open-fronthaul M-plane). The interface 210 may be implemented by use of various known technologies to support wired or wireless communication of the electronic device 104 with the O-RAN interfaces 112.

The display device 212 may include suitable logic, circuitry, and interfaces that may be configured to render the first log information (for example, the log information 120) associated with the first network component (i.e., the electronic device 104). The display device 212 may be a touch screen which may enable a user to provide user-inputs via the display device 212. The touch screen may be at least one of a resistive touch screen, a capacitive touch screen, or a thermal touch screen. The display device 212 may be realized through several known technologies such as, but not limited to, a Liquid Crystal Display (LCD) display, a Light Emitting Diode (LED) display, a plasma display, or an Organic LED (OLED) display technology, or other display devices. In accordance with an embodiment, the display device 212 may refer to a display screen of a head mounted device (HMD), a smart-glass device, a see-through display, a projection-based display, an electro-chromic display, or a transparent display.

Modifications, additions, or omissions may be made to the example electronic device 104 without departing from the scope of the present disclosure. For example, in some embodiments, the example electronic device 104 may include any number of other components that may not be explicitly illustrated or described for the sake of brevity.

FIG. 3 is a diagram that illustrates an exemplary execution pipeline for facilitating fast pre-sorted security logging for open-radio access networks (O-RANS), in accordance with an embodiment of the disclosure. FIG. 3 is described in conjunction with elements from FIG. 1, and FIG. 2. With reference to FIG. 3, there is shown an execution pipeline 300. The exemplary execution pipeline 300 may include a sequence of operations that may be executed by the processor 202 of the electronic device 104 of FIG. 1 for facilitating fast pre-sorted security logging for an O-RAN. In the execution pipeline 300, there is shown a sequence of operations that may start from 302 and end at 314. FIG. 3 further includes a first event log 302A, a first digest 304A, a first set of encryption keys 306A, a first set of encrypted digests 308A, and first log information 310A.

At 302, an operation for event log detection may be executed. In at least one embodiment, the processor 202 may be configured to detect the first event log 302A. The first event log 302A may be associated with a first network component (i.e., the electronic device 104) of an O-RAN. The detection of the first event log 302A may be based on inclusion or registration of the first event log 302A on a depository of the first network component. The first event log 302A may be included in the depository for recording an occurrence of one or more events that may be of importance and needs to be recognized. The first event log 302A may include information associated with each of the one or more events that may be arranged in a particular order. The information associated with an event may include a timestamp of occurrence of each of the event, a description of the event, severity of the event, applications associated with the event, or any other particulars associated with the event. The registration or inclusion of the first event log 302A on the depository of the first network component may be based on the occurrence of the one or more events in the first network component. Once the first event log 302A is included in the memory 204, the first event log 302A may be detected.

In accordance with an embodiment, the O-RAN may include a set of network components. The set of network components may include the first network component. The set of network components further include a second network component that may be different from the first network component. Each network component of the set of network components may be different from remaining network components of the set of network components. The set of network components may include at least one of: an open-cloud (O-cloud) component, a radio unit (RU) component, a distributed unit (DU) component, a centralized unit (CU) component, or a radio intelligent controller (RIC) component. The CU component may include a CU-user plane (CU-UP) component and a CU-control plane (CU-CP) component. The RIC component may include a near-real time RIC (near-RT RIC) component and a non-real time RIC (non-RT RIC) component. The non-RT RIC component may be included in the service management component 106.

At 304, a digest generation operation may be executed. In at least one embodiment, the processor 202 may be configured to generate the first digest 304A associated with the detected first event log 302A. The generation of the first digest 304A may be triggered based on the detection of the first event log 302A. In an embodiment, the first digest 304A may be generated based on a digest generator and the first event log 302A. The processor 202 may apply a digest generator on the first event log 302A. The digest generator may be included in the first network component (i.e., the electronic device 104). The digest generator may apply a hash function or a digest function on the first event log 302A for generation of a hash of the first event log 302A as output of the digest generator. The hash of the first event log 302A, i.e., the output, may correspond to the first digest 304A. The digest function may be a mathematical function that may apply a series of mathematical operations on the first event log 302A such that the hash of the first event log 302A, i.e., the first digest 304A, is generated. The first digest 304A may be a digital summary of the first event log 302A that may act as a digital identifier of the first event log 302A.

At 306, an operation of encryption keys generation may be executed. In at least one embodiment, the processor 202 may be configured to generate each encryption key of the first set of encryption keys 306A, based on an encryption layer of a set of encryption layers, and the first event log 302A. In an example, the set of encryption layers may include a first encryption layer, a second encryption layer, and a third encryption layer. Each encryption layer may be associated with “4” different encryption keys. The encryption key for each encryption layer may be generated. Thus, a total of 12 encryption keys (4 keys per encryption layer*3 encryption layers) may be generated. Out of the total 12 encryption keys, one encryption key may be selected from each encryption layer. That is, a first encryption key may be generated for the first encryption layer, a second encryption key may be generated for the second encryption layer, and a third encryption key may be generated for the third encryption layer. Thus, the first set of encryption keys 306A may include the first encryption key, the second encryption key, and the third encryption key.

In accordance with an embodiment, the generated encryption keys for the set of encryption layers may correspond to secret encryption keys. The key-delivery component 110 may transmit or distribute the secret encryption keys to the set of network components (i.e., all network components of the O-RAN). Thus, both the first network component and the second network component (and each of the other network components of the O-RAN) may receive the same secret encryption keys.

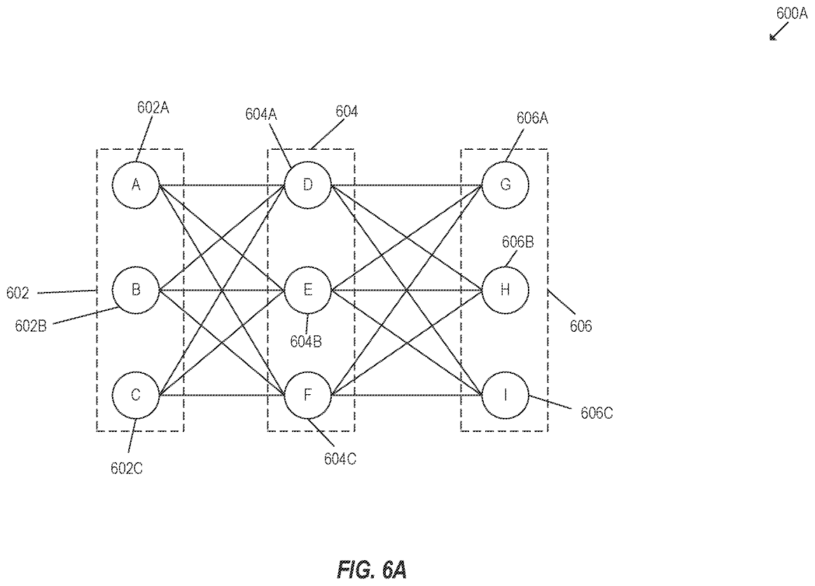

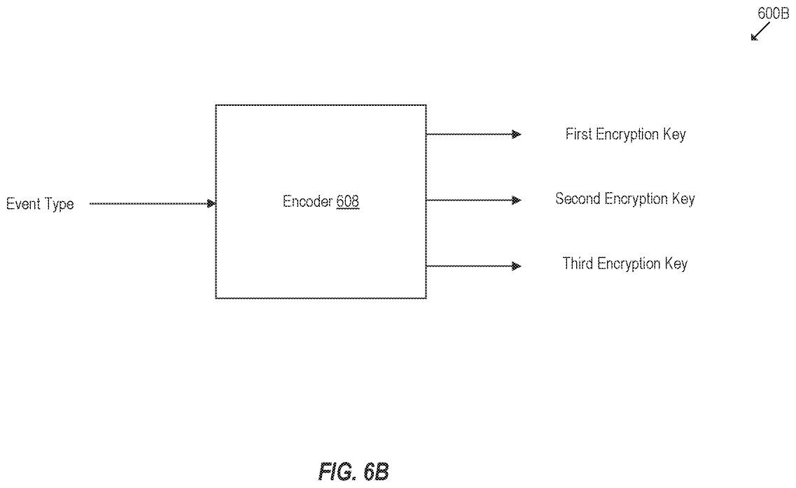

In accordance with an embodiment, the processor 202 may be configured determining a third set of encryption keys associated with the set of encryption layers based on a combination of the set of encryption keys 122 associated with each of the set of encryption layers. The generation of the first set of encryption keys 306A associated with the set of encryption layers for the first digest 304A may be based on the third set of encryption keys. The third set of encryption keys may be combination of encryption keys associated with each layer of set of encryption layers. Details related to the third set of encryption keys are further provided, for example, in FIG. 6A.

At 308, an operation of encrypted digest generation may be executed. In at least one embodiment, the processor 202 may be configured to generate the first set of encrypted digests 308A for the first digest 30A, based on the first set of encryption keys 306A. In an example, the first set of encryption keys 306A may include an encryption key “A” associated with a first encryption layer, an encryption key “E” associated with a second encryption layer, and an encryption key “H” associated with a third encryption layer. Herein, a first encrypted digest based on an application of the encryption key “A” on the first digest 304A associated with the first event log 302A. A second encrypted digest based on an application of the encryption key “E” on the first digest 304A associated with the first event log 302A. A third encrypted digest may be generated based on an application of the encryption key “H” on the first digest 304A associated with the first event log 302A. The first set of encrypted digests 308A may thus include the first encrypted digest, the second encrypted digest, and the third encrypted digest.

At 310, an operation of first log information generation may be executed. In at least one embodiment, the processor 202 may be configured to generate the first log information 310A associated with the first network component (for example, the electronic device 104), based on the first event log 302A and the first set of encrypted digests 308A. In an embodiment, a concatenation operation may be applied on the first event log 302A and the first set of encrypted digests 308A, wherein the generation of the first log information 310A may be further based on the concatenation operation. In an example, the first set of encrypted digests 308A may include the first encrypted digest, the second encrypted digest, and the third encrypted digest. Herein, the first event log 302A may be concatenated with the first encrypted digest, the second encrypted digest, and the third encrypted digest to generate the first log information 310A.

At 312, an operation of lo information transmission may be executed. In at least one embodiment, the processor 202 may be configured to transmit the first log information 310A to the service management component 106 (i.e., the service management and orchestration (SMO)) of the O-RAN. The service management component 106 may be configured to pre-sort the first log information 310A, based on the first set of encrypted digests 308A. The service management component 106 may be configured to receive the first log information 310A from the first network component. Thereafter, the service management component 106 may pre-sort the first log information 310A by analyzing the first set of encrypted digests 308A. Therefore, the service management component 106 may not need to examine the contents of the first event log 302A. Thus, a processing time needed for examining the first event log 302A may be saved. Hence, a time required to respond and mitigate security threats may be decreased. This may increase O-RAN security and operational efficiency.

In an embodiment, the processor 202 may be configured to determine an event type of the first event log 302A based on the generation of the first set of encryption keys 306A associated with the set of encryption layers for the first digest 304A, wherein the first log information 310A may be pre-sorted based on the event type. It may be noted that an event type may correspond to a type of a security breach.

In an embodiment, the event type of the first event log 302A may be at least one of, but not limited to, a successful authentication attempt event type, a failed authentication attempt event type, a file accesses event type, a data access event type, a security policy change event type, an account change event type, an identity change event type, a privilege usage event type, or an actor identification event type. It may be appreciated that the successful authentication attempt event type may be an event wherein a login to a system, a server, and the like may be successful based on a successful authentication. In such a case, the credentials associated with an authentication may be correct. For example, a correct user name and a correct password may have been provided for the successful authentication. The failed authentication attempt event type may be an event wherein a login to a system, a server, and the like may be unsuccessful based on a unsuccessful authentication. In such a case, the credentials associated with an authentication may be incorrect. The file accesses event type may be an event where a file may be successfully accessed by an authorized or an unauthorized personnel or entity. The data access event type may be an event where data may be successfully accessed by an authorized or an unauthorized personnel or entity. The security policy change event type may be an event where a security policy may be altered by an authorized or an unauthorized personnel or entity. The account change event type may be an event where an account may be altered by an authorized or an unauthorized personnel or entity. The identity change event type may be an event where an identity may be altered by an authorized or an unauthorized personnel or entity.

At 314, an operation of log information rendering may be executed. In at least one embodiment, the processor 202 may be configured to control the first display device (for example, the display device 212) to render the first log information 310A.

In an embodiment, the service management component 106 may be further configured to validate, based on the first set of encrypted digests 308A, an authenticity of at least one of the first event log 302A or the first network component. The first display device may be controlled to render the first log information 310A based on the authenticity. For obtaining the first set of encrypted digests 308A, the service management component 106 may extract, from the received first log information 310A, the first event log 302A and the first set of encrypted digests 308A.

In accordance with an embodiment, the service management component 106 may be configured to receive the first set of encryption keys 306A from the key-delivery component 110. Based on the first set of encryption keys 306A, the service management component 106 may decrypt each of the first set of encrypted digests 308A. Based on the decryption of the first set of encrypted digests 308A, a result of validation of the first event log 302A may be obtained. The result may indicate whether the first event log 302A is authentic or inauthentic (i.e., fake).

Embodiments of the disclosure may facilitate fast pre-sorted logging scheme capable of avoiding event log content examination. The processor 202 may generate each encryption key of the first set of encryption keys 306A based on the encryption layer of the set of encryption layers. Further, multiple encryption layers of the encryption keys may provide a greater number of new encryption keys combinations that may be generated in a structured fashion. In an example, for a given “M” number of encryption layers, a first encryption layer may be associated with “N₁” number of encryption keys, a second encryption layer may be associated with “N₂” number of encryption keys, . . . , and an “M^{th}” encryption layer may be associated with “N_{M}” number of encryption keys. A total number of required encryption keys may be a summation of “N₁”, “N₂”, . . . , and “N_{M}”. A number of event types that may be supported may be a product of “N₁”, “N₂”, . . . , and “N_{M}”. That is, if a number of event types is assigned as “27”, then a typical approach may deploy “27” encryption keys, while the processor 202 may be able to handle “27” event types with just “9” encryption keys. Further, typically, an average number of verifications required may be “14” for “27” event types. However, the disclosed technique may require “6” average number of verifications. Therefore, the processor 204 may require fewer number of encryption keys for a given number of event types. Further, a number of verifications required may be also lowered.

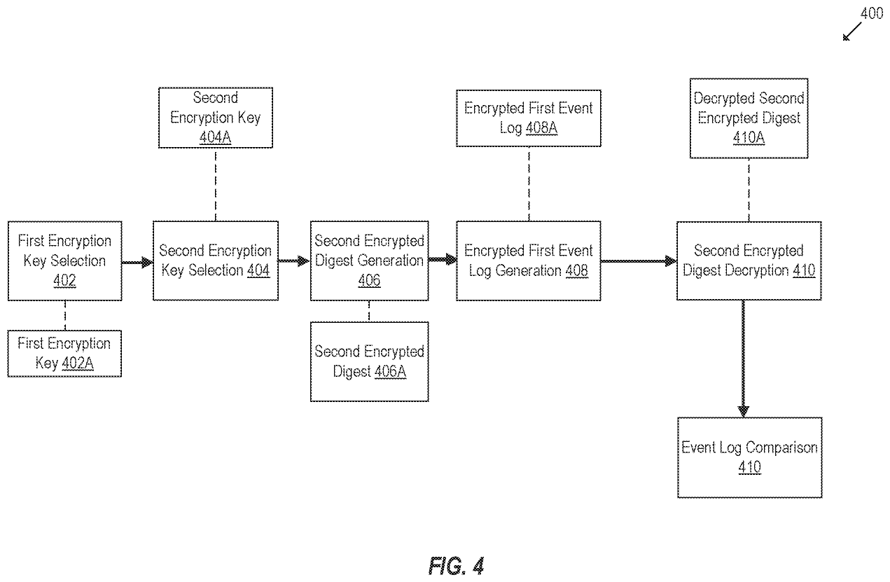

FIG. 4 is a diagram that illustrates an exemplary execution pipeline for generation of a first set of encryption keys, in accordance with an embodiment of the disclosure. FIG. 4 is described in conjunction with elements from FIG. 1, FIG. 2, and FIG. 3. With reference to FIG. 4, there is shown an execution pipeline 400. The exemplary execution pipeline 400 may include a sequence of operations that may be executed by the processor 202 of the electronic device 104 of FIG. 1 for generation of the first set of encryption keys. In the execution pipeline 400, there is shown a sequence of operations that may start from 402 and end at 410. FIG. 4 further includes a first encryption key 402A, a second encryption key 404A, a second encrypted digest 406A, an encrypted first event log 408A, and a decrypted second encrypted digest 410A.

At 402, an operation of a first encryption key selection may be executed. In at least one embodiment, the processor 202 may be configured to select the first encryption key 402A of the first set of encryption keys (for example, the first set of encryption keys 306A of FIG. 3) that may be associated with a first encryption layer of the set of encryption layers. The first encryption key 402A may be selected from a second set of encryption keys corresponding to the first encryption layer of the set of encryption keys 122. The set of encryption keys 122 may include a universal set of encryption keys associated with each encryption layer of the set of encryption layers. The first set of encryption keys may include encryption keys selected for each encryption layer of the set of encryption layers. In an example, the set of encryption layers may include “3” encryption layers. A first encryption layer may be associated with an encryption key “A”, an encryption key “B”, and an encryption key “C”. A second encryption layer may be associated with an encryption key “D”, an encryption key “E”, and an encryption key “F”. A third encryption layer may be associated with an encryption key “G”, an encryption key “H”, and an encryption key “I”. Thus, the set of encryption keys 122 may include the encryption key “A”, the encryption key “B”, the encryption key “C”, the encryption key “D”, the encryption key “E”, the encryption key “F”, the encryption key “G”, the encryption key “H”, and the encryption key “I”. Further, the second set of encryption keys corresponding to the first encryption layer may be the encryption key “A”, the encryption key “B”, and the encryption key “C”. The encryption key “B” may be selected for the first encryption layer, the encryption key “E” may be selected for the second encryption layer, and the encryption key “H” may be selected for the third encryption layer. Herein, the first encryption key 402A may be the encryption key “B”.

At 404, an operation of a second encryption key selection may be executed. In at least one embodiment, the processor 202 may be configured to select the second encryption key 404A associated with the first encryption layer, from the second set of encryption keys associated with the first encryption layer. Herein, the processor 202 may be configured to select the second encryption key 404A one by one from the second set of encryption keys. In an example, the second set of encryption keys may include an encryption key “X”, an encryption key “Y”, and an encryption key “Z”. During a first iteration, the encryption key “X” maybe selected as the second encryption key 404A.

At 406, an operation of a second encrypted digest generation may be executed. In at least one embodiment, the processor 202 may be configured to generate the second encrypted digest 406A from the first digest (for example, the first digest 304A) based on the second encryption key 404A and the first digest (for example, the first digest 304A). Herein, the second encryption key 404A may be applied on the first digest (for example, the first digest 304A) to generate the second encrypted digest 406A.

At 408, an operation of an encrypted first event log generation may be executed. In at least one embodiment, the processor 202 may be configured to generate the encrypted first event log 408A based on the second encryption key 404A and the first event log (for example, the first event log 302A). Herein, the encrypted first event log 408A may be concatenated with the first event log (for example, the first event log 302A) to generate the encrypted first event log 408A.

At 410, an operation of a second encrypted digest decryption may be executed. In at least one embodiment, the processor 202 may be configured to decrypt the second encrypted digest 406A. Based on the decryption, the decrypted second encrypted digest 410A may be generated.

At 412, an operation of an event log comparison may be executed. In at least one embodiment, the processor 202 may be configured to compare the encrypted first event log 408A and the decrypted second encrypted digest 410A. The generation of the first set of encryption keys (for example, the first set of encryption keys 306A of FIG. 3) associated with the set of encryption layers for the first digest (for example, the first digest 304A of FIG. 3) may be based on the comparison. Herein, in case the encrypted first event log 408A and the decrypted second encrypted digest 410A is same, then the second encryption key 404A may be selected as the first encryption key 402A. However, in case, the encrypted first event log 408A and the decrypted second encrypted digest 410A differ, then the second encryption key 404A may be re-selected from the second set of encryption keys. Similarly, encryption keys associated with other encryption layers may be generated to generate the first set of encryption keys (for example, the first set of encryption keys 306A of FIG. 3).

FIG. 5 is a diagram that illustrates an exemplary architecture of an O-RAN, in accordance with an embodiment of the disclosure. FIG. 5 is described in conjunction with elements from FIG. 1, FIG. 2, FIG. 3, and FIG. 4. With reference to FIG. 5, there is shown a block diagram of an exemplary O-RAN architecture 500. The O-RAN architecture 500 may include an O-Cloud 502, an RU 504, a DU 506, a CU 508, a near-RT RIC 510, an SMO 512, and an SIEM 514. In at least one embodiment the CU 508 may include a CU-CP 508A and a CU-UP 508B. The O-RAN architecture 500 may include configurations 516 that may be used for streaming of event logs and options that may be used for collection and issuing notifications. Each of the O-Cloud 502, the RU 504, the DU 506, the CU 508 (i.e., the CU-CP 508A and the CU-UP 508B), the near-RT RIC 510, the SMO 512, and the SIEM 514, may be disaggregated radio access network components. Details of functionality of each of the O-Cloud 502, the RU 504, the DU 506, the CU 508 (i.e., the CU-CP 508A and the CU-UP 508B), the near-RT RIC 510, the SMO 512, and the SIEM 514, are included, for example, in FIG. 1.

In accordance with an embodiment, the electronic device 104 may be one of devices or set of devices associated with the O-Cloud 502, the RU 504, the DU 506, the CU-CP 508A, the CU-UP 508B, or the near-RT RIC 510. The SMO 512 may correspond to the service management component 106. Further, the SIEM 514 may correspond to the security management component 108. The CU-CP 508A and the CU-UP 508B may be connected to each other via the E1 interface. The near-RT RIC 510 may be connected to each of the CU-CP 508A and the CU-UP 508B via the E2 interface. The SMO 512 (specifically the non-RT RIC (not shown) included in the SMO 512) may be connected to each of the DU 506, the CU-CP 508A, the CU-UP 508B, or the near-RT RIC 510, via the O1 interface. The SMO 512 may be connected to the O-Cloud 502, via the O2 interface. The SMO 512 may be connected to each of the RU 504 via the open-fronthaul M-plane. Further, the RU 504 and the DU 506 may be connected to each other via the open-fronthaul M-plane.

The configurations 516 may include protocols associated with pulling of event logs by the SMO 512 from depositories of each of the o-Cloud 502, the RU 504, the DU 506, the CU-CP 508A, the CU-UP 508B, or the near-RT RIC 510. The pulling of the event logs may be scheduled based on the protocols. Once the event logs are pulled, the SMO 512 may validate authenticity of each of the event logs. The SMO 512 may stream results of validation of the authenticity of the event logs. The streaming of the results may be continuous based on the protocols. Further, the configurations 516 may include options, based on which notification and collection agents may execute actions such as collect and issue notifications in real-time, near real-time, or when a memory configured to store the collected notifications is full. The notification and collection agents may be included in each of RU 504, the DU 506, the CU-CP 508A, the CU-UP 508B, the near-RT RIC 510, or the SMO 512.

It should be noted that the O-RAN architecture 500 is for exemplary purposes and should not be construed to limit the scope of the disclosure.

FIG. 6A is a diagram that illustrates an exemplary scenario for determination of a set of encryption keys, in accordance with an embodiment of the disclosure. FIG. 6 is described in conjunction with elements from FIG. 1, FIG. 2, FIG. 3, FIG. 4, and FIG. 5. With reference to FIG. 6A, there is shown an exemplary scenario 600A. The scenario 600A may include a first encryption layer 602, a second encryption layer 604, and a third encryption layer 606. The first encryption layer 602 may include a node 602A associated with an encryption key “A”, a node 602B associated with an encryption key “B”, and a node 602C associated with an encryption key “C”. The second encryption layer 604 may include a node 604A associated with an encryption key “D”, a node 604B associated with an encryption key “E”, and a node 604C associated with an encryption key “F”. The third encryption layer 606 may include a node 606A associated with an encryption key “G”, a node 606B associated an encryption key “H”, and a node 606C associated an encryption key “I”. A set of operations associated with the scenario 600A is described herein.

With reference to FIG. 6A, an ensemble of nodes in each unique path from an input layer that is, the first encryption layer 602 to an output layer that is, the third encryption layer 606 may define a new first set of encryption keys. Thus, the third set of encryption keys may be “ADG”, “ADH”, “ADI”, “AEG”, “AEH”, “AEI”, “AFG”, “AFH”, “AFI”, “BDG”, “BDH”, “BDI”, “BEG”, “BEH”, “BEI”, “BFG”, “BFH”, “BFI”, “CDG”, “CDH”, “CDI”, “CEG”, “CEH”, “CEI”, “CFG”, “CFH”, and “CFI”. In an example, “AEG” may be selected. Therefore, the first set of encryption keys may be “A”, “E”, and “G”.

It should be noted that the exemplary scenario 600A is for exemplary purposes and should not be construed to limit the scope of the disclosure.

FIG. 6B is a diagram that illustrates an exemplary scenario for determination of a first set of encryption keys based on an application of an encoder model, in accordance with an embodiment of the disclosure. FIG. 6B is described in conjunction with elements from FIG. 1, FIG. 2, FIG. 3, FIG. 4, FIG. 5, and FIG. 6A. With reference to FIG. 6B, there is shown an exemplary scenario 600B. The scenario 600B may include an encoder model 608. A set of operations associated with the scenario 600B is described herein.

In an embodiment, the first set of encryption keys (for example, the first set of encryption keys 306A of FIG. 3) may be generated based on the encoder model 608, the set of encryption layers, and the first digest (for example, the first digest 304A). With reference to FIG. 6B, the first digest (for example, the first digest 304A) may be provided as an input to the encoder model 608. The encoder model 608 may generate the first set of encryption keys (for example, the first set of encryption keys 306A of FIG. 3) based on an event type of an event log associated with the first digest. The first set of encryption keys (for example, the first set of encryption keys 306A of FIG. 3) may include a first encryption key that may be associated with a first encryption layer, a second encryption key that may be associated with a second encryption layer, and a third encryption key that may be associated with a third encryption layer.

It should be noted that the exemplary scenario 600B is for exemplary purposes and should not be construed to limit the scope of the disclosure.

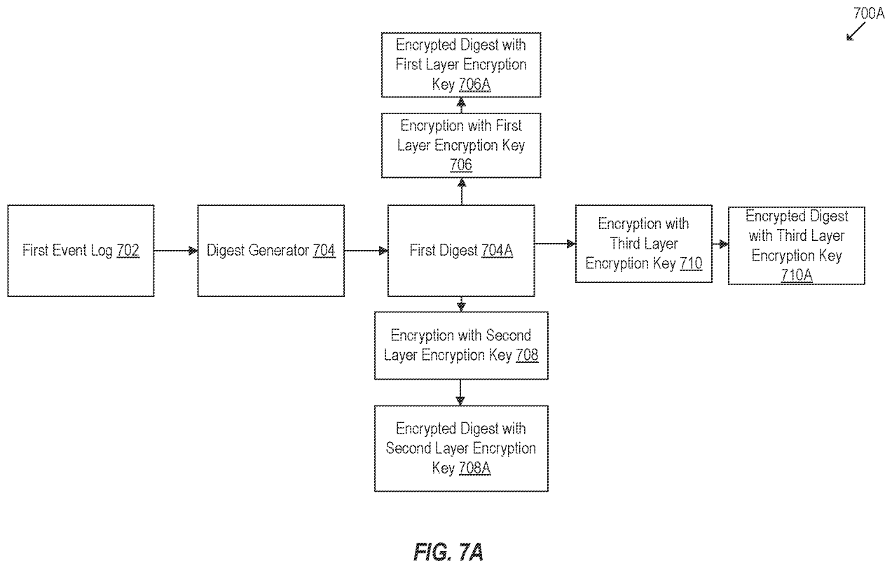

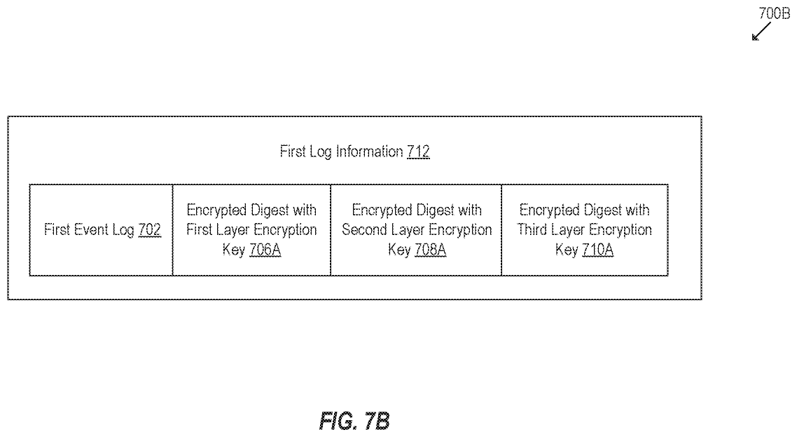

FIG. 7A is a diagram that illustrates an exemplary scenario for generation of a first set of encrypted digests, in accordance with an embodiment of the disclosure. FIG. 7A is described in conjunction with elements from FIG. 1, FIG. 2, FIG. 3, FIG. 4, FIG. 5, FIG. 6A, and FIG. 6B. With reference to FIG. 7A, there is shown an exemplary scenario 700A. The scenario 700A may include a first event log 702, a digest generator 704, a first digest 704A, an encrypted digest with first layer encryption key 706A, an encrypted digest with second layer encryption key 708A, an encrypted digest with third layer encryption key 710A. The exemplary scenario 700A may include exemplary operations 706, 708, and 710 that may be executed by any computing system, for example, by the electronic device 104 of FIG. 1 or by the processor 202 of FIG. 2. A set of operations associated with the scenario 700A is described herein.

With reference to FIG. 7A, the digest generator 704 may be applied on the first event log 702. The digest generator 704 may generate the first digest 704A. Upon generation of the first digest 704A, at 706, an operation of encryption with a first layer encryption key may be executed. In an embodiment, the processor 202 may be configured to apply the first layer encryption key on the generated first digest 704A. Based on the application of the first layer encryption key, the encrypted digest with first layer encryption key 706A may be generated.

At 708, an operation of encryption with a second layer encryption key may be executed. In an embodiment, the processor 202 may be configured to apply the second layer encryption key on the generated first digest 704A. Based on the application of the second layer encryption key, the encrypted digest with second layer encryption key 708A may be generated.

At 710, an operation of encryption with a third layer encryption key may be executed. In an embodiment, the processor 202 may be configured to apply the third layer encryption key on the generated first digest 704A. Based on the application of the third layer encryption key, the encrypted digest with third layer encryption key 710A may be generated. The first set of encrypted digests including the encrypted digest with first layer encryption key 706A, the encrypted digest with second layer encryption key 708A, and the encrypted digest with third layer encryption key 710A may be thus generated.

It should be noted that the exemplary scenario 700A is for exemplary purposes and should not be construed to limit the scope of the disclosure.

FIG. 7B is a diagram that illustrates an exemplary scenario first log information, in accordance with an embodiment of the disclosure. FIG. 7B is described in conjunction with elements from FIG. 1, FIG. 2, FIG. 3, FIG. 4, FIG. 5, FIG. 6A, FIG. 6B, and FIG. 7A. With reference to FIG. 7B, there is shown an exemplary scenario 700B. The scenario 700B may include the first event log 702, the encrypted digest with first layer encryption key 706A, the encrypted digest with second layer encryption key 708A, the encrypted digest with third layer encryption key 710A, and first log information 712. A set of operations associated with the scenario 700B is described herein.

With references to FIG. 7A and FIG. 7B, in order to generate the first log information 712, the processor 202 may apply the concatenation operation on the first event log 702 and the first set of encrypted digests. That is, the concatenation operation may be applied on the first event log 702, the encrypted digest with first layer encryption key 706A, the encrypted digest with second layer encryption key 708A, and the encrypted digest with third layer encryption key 710A. Based on the application of the concatenation operation, the first log information 712 may be generated.

It should be noted that the exemplary scenario 700B is for exemplary purposes and should not be construed to limit the scope of the disclosure.

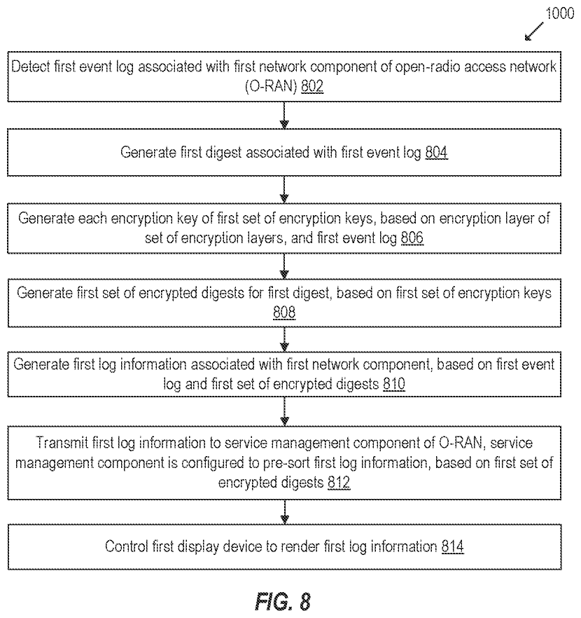

FIG. 8 is a diagram that illustrates a flowchart of an example method for fast pre-sorted security logging for open-radio access networks (O-RANS), in accordance with an embodiment of the disclosure. FIG. 8 is described in conjunction with elements from FIG. 1, FIG. 2, FIG. 3, FIG. 4, FIG. 5, FIG. 6A, FIG. 6B, FIG. 7A, and FIG. 7B. With reference to FIG. 8, there is shown a flowchart 800. The method illustrated in the flowchart 800 may start at 802 and may be performed by any suitable system, apparatus, or device, such as, by the example electronic device 104 of FIG. 1, or the processor 202 of FIG. 2. Although illustrated with discrete blocks, the steps and operations associated with at least one block of the flowchart 800 may be divided into additional blocks, combined into fewer blocks, or eliminated, depending on the particular implementation.

At block 802, a first event log (for example, the event log 114), associated with a first network component (such as, the electronic device 104) of an O-RAN (such as, the system 102), may be detected. In an embodiment, the processor 202 may be configured to detect the first event log (for example, the event log 114) that may be associated with the first network component (i.e., the electronic device 104) of the O-RAN (i.e., the system 102). Details of the detection of the first event log (for example, the event log 114) associated with the first network component (i.e., the electronic device 104) are further provided, for example, in FIG. 3.

At block 804, a first digest (for example, the digest 116), associated with the first event log (for example, the event log 114), may be generated. In an embodiment, the processor 202 may be configured to generate the first digest (for example, the digest 116) associated with the first event log (for example, the event log 114). Details of generation of the first digest (for example, the digest 116) associated with the first event log (for example, the event log 114) are further provided, for example, in FIG. 1 and FIG. 3.

At block 806, each encryption key of a first set of encryption keys (for example, the first set of encryption keys 306A of FIG. 3), may be generated based on an encryption layer of a set of encryption layers and the first event log (for example, the first event log 302A of FIG. 3). In an embodiment, the processor 202 may be configured to generate each encryption key of the first set of encryption keys (for example, the first set of encryption keys 306A of FIG. 3) based on an encryption layer of the set of encryption layers and the first event log (for example, the first event log 302A of FIG. 3). Details of generation of each encryption are further provided, for example, in FIG. 1 and FIG. 3.

At 808, a first set of encrypted digests (for example, the first set of encrypted digests 308A of FIG. 3) may be generated for the first digest (for example, the first digest 304A of FIG. 3), based on the first set of encryption keys (for example, the first set of encryption keys 306A of FIG. 3). In an embodiment, the processor 202 may be configured to generate the first set of encrypted digests (for example, the first set of encrypted digests 308A of FIG. 3) for the first digest (for example, the first digest 304A of FIG. 3), based on the first set of encryption keys (for example, the first set of encryption keys 306A of FIG. 3). Details of generation of the first set of encrypted digests are further provided, for example, in FIG. 1 and FIG. 3.

At 810, first log information (for example, the first log information 310A of FIG. 3A) associated with the first network component (i.e., the electronic device 104) may be generated based on the first event log (for example, the first event log 302A of FIG. 3) and the first set of encrypted digests (for example, the first set of encryption keys 306A of FIG. 3). In an embodiment, the processor 202 may be configured to generate the first log information (for example, the first log information 310A of FIG. 3A) associated with the first network component (i.e., the electronic device 104) based on the first event log (for example, the first event log 302A of FIG. 3) and the first set of encrypted digests (for example, the first set of encryption keys 306A of FIG. 3). Details of generation of the first log information are further provided, for example, in FIG. 1 and FIG. 3.

At 812, the first log information (for example, the first log information 310A of FIG. 3A) may be transmitted to a service management component (such as the service management component 106 of FIG. 1) of the O-RAN (for example, the system 102 of FIG. 1). Herein, the service management component (such as the service management component 106 of FIG. 1) may be configured to pre-sort the first log information for example, the first log information 310A of FIG. 3A), based on the first set of encrypted digests (for example, the first set of encryption keys 306A of FIG. 3). In an embodiment, the processor 202 may be configured to transmit the first log information (for example, the first log information 310A of FIG. 3A) to the service management component (such as the service management component 106 of FIG. 1) of the O-RAN (for example, the system 102 of FIG. 1). The service management component (such as the service management component 106 of FIG. 1) may be configured to pre-sort the first log information for example, the first log information 310A of FIG. 3A), based on the first set of encrypted digests (for example, the first set of encryption keys 306A of FIG. 3). Details of transmission of the first log information are further provided, for example, in FIG. 1 and FIG. 3.

At 814, a first display device (such as the display device 212 of FIG. 2) may be controlled to render the first log information (for example, the first log information 310A of FIG. 3A). In an embodiment, the processor 202 may be configured to control the first display device (such as the display device 212 of FIG. 2) to render the first log information (for example, the first log information 310A of FIG. 3A). Details of rendering of the first log information are further provided, for example, in FIG. 1 and FIG. 3. Control may pass to end.

Although the flowchart 800 is illustrated as discrete operations, such as 802 804, 806, 808, 810, 812, and 814, the disclosure is not so limited. However, in certain embodiments, such discrete operations may be further divided into additional operations, combined into fewer operations, or eliminated, depending on the particular implementation without detracting from the essence of the disclosed embodiments.

Various embodiments of the disclosure may provide one or more non-transitory computer-readable storage media configured to store instructions that, in response to being executed, cause a first networking component (such as, the electronic device 104 of FIG. 1) of an O-RAN (such as the system 102 of FIG. 1) to perform operations. The operations may include detecting a first event log (such as the first event log (for example, the event log 114 of FIG. 1)) associated with a first network component (i.e., the electronic device 104 of FIG. 1) of the O-RAN (i.e., the system 102 of FIG. 1). The operations may further include generating a first digest (such as the first digest (for example, the digest 116 of FIG. 1)) associated with the first event log (i.e., the first event log (for example, the event log 114 of FIG. 1)). The operations may further include generating each encryption key of a first set of encryption keys (for example, the first set of encryption keys 306A of FIG. 3) based on an encryption layer of a set of encryption layers and the first event log (for example, the first event log 302A of FIG. 3). The operations may further include generating a first set of encrypted digests (for example, the first set of encrypted digests 308A of FIG. 3) for the first digest (for example, the first digest 304A of FIG. 3), based on the first set of encryption keys (for example, the first set of encryption keys 306A of FIG. 3). The operations may further include generating first log information (for example, the first log information 310A of FIG. 3A) associated with the first network component (i.e., the electronic device 104) based on the first event log (for example, the first event log 302A of FIG. 3) and the first set of encrypted digests (for example, the first set of encryption keys 306A of FIG. 3). The operations may further include transmitting the first log information (for example, the first log information 310A of FIG. 3A) to a service management component (such as the service management component 106 of FIG. 1) of the O-RAN (for example, the system 102 of FIG. 1). The service management component (such as the service management component 106 of FIG. 1) may be configured to pre-sort the first log information for example, the first log information 310A of FIG. 3A), based on the first set of encrypted digests (for example, the first set of encryption keys 306A of FIG. 3). The operations may further include controlling a first display device (such as the display device 212 of FIG. 2) to render the first log information (for example, the first log information 310A of FIG. 3A).

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, executed by a processor, comprising:
detecting a first event log associated with a first network component of an open-radio access network (O-RAN);
generating a first digest associated with the first event log;
generating each encryption key of a first set of encryption keys, based on an encryption layer of a set of encryption layers, and the first event log;
generate a first set of encrypted digests for the first digest, based on the first set of encryption keys;
generating first log information associated with the first network component, based on the first event log and the first set of encrypted digests;
transmitting the first log information to a service management component of the O-RAN,
the service management component is configured to pre-sort the first log information, based on the first set of encrypted digests; and
controlling a first display device to render the first log information.

2. The method according to claim 1, wherein the first digest is generated based on a digest generator and the first event log.

3. The method according to claim 1, wherein the first set of encryption keys is generated based on an encoder model, the set of encryption layers, and the first digest.

4. The method according to claim 1, wherein
a first encryption key of the first set of encryption keys is associated with a first encryption layer of the set of encryption layers, and
the first encryption key is selected from a second set of encryption keys corresponding to the first encryption layer of the set of encryption keys.

5. The method according to claim 4, further comprising:
selecting a second encryption key associated with the first encryption layer, from the second set of encryption keys associated with the first encryption layer;
generating a second encrypted digest from the first digest based on the second encryption key and the first digest;
generating an encrypted first event log based on the second encryption key and the first event log;
decrypting the second encrypted digest; and
comparing the encrypted first event log and the decrypted second encrypted digest, wherein
the generation of the first set of encryption keys associated with the set of encryption layers for the first digest is based on the comparison.

6. The method according to claim 1, further comprising:
determining a third set of encryption keys associated with the set of encryption layers based on a combination of the set of encryption keys associated with each of the set of encryption layers, wherein
the generation of the first set of encryption keys associated with the set of encryption layers for the first digest is based on the third set of encryption keys.

7. The method according to claim 1, further comprising:
determining an event type of the first event log based on the generation of the set of encryption keys associated with the set of encryption layers for the first digest, wherein
the first event information is pre-sorted based on the event type.

8. The method according to claim 7, wherein the event type of the first event log is at least one of:
a successful authentication attempt event type,
a failed authentication attempt event type,
a file accesses event type,
a data access event type,
a security policy change event type,
an account change event type,
an identity change event type,
a privilege usage event type, or
an actor identification event type.

9. The method according to claim 1, further comprising:
applying a concatenation operation on the first event log and the first set of encrypted digests, wherein
the generation of the first log information is further based on the concatenation operation.

10. The method according to claim 1, wherein the O-RAN includes a set of network components, the set of network components including at least one of:
an open-cloud (O-cloud) component,
a radio unit (RU) component,
a distributed unit (DU) component,
a centralized unit (CU) component, or
a radio intelligent controller (RIC) component.

11. The method according to claim 1, wherein
the service management component is further configured to validate, based on the first set of encrypted digests, an authenticity of at least one of the first event log or the first network component, and
the first display device is controlled to render the first log information based on the authenticity.

12. One or more non-transitory computer-readable storage media configured to store instructions that, in response to being executed, cause an electronic device to perform operations, the operations comprising:
detecting a first event log associated with a first network component of an open-radio access network (O-RAN);
generating a first digest associated with the first event log;
generating each encryption key of a first set of encryption keys, based on an encryption layer of a set of encryption layers, and the first event log;
generate a first set of encrypted digests for the first digest, based on the first set of encryption keys;
generating first log information associated with the first network component, based on the first event log and the first set of encrypted digests;
transmitting the first log information to a service management component of the O-RAN,
the service management component is configured to pre-sort the first log information, based on the first set of encrypted digests; and
controlling a first display device to render the first log information.

13. The one or more non-transitory computer-readable storage media according to claim 12, wherein the first digest is generated based on a digest generator and the first event log.

14. The one or more non-transitory computer-readable storage media according to claim 12, wherein the first set of encryption keys is generated based on an encoder model, the set of encryption layers, and the first digest.

15. The one or more non-transitory computer-readable storage media according to claim 12, wherein
a first encryption key of the first set of encryption keys is associated with a first encryption layer of the set of encryption layers, and
the first encryption key is selected from a second set of encryption keys corresponding to the first encryption layer of the set of encryption keys.

16. The one or more non-transitory computer-readable storage media according to claim 15, the operations further comprising:
selecting a second encryption key associated with the first encryption layer, from the second set of encryption keys associated with the first encryption layer;
generating a second encrypted digest from the first digest based on the second encryption key and the first digest;
generating an encrypted first event log based on the second encryption key and the first event log;
decrypting the second encrypted digest; and
comparing the encrypted first event log and the decrypted second encrypted digest, wherein
the generation of the first set of encryption keys associated with the set of encryption layers for the first digest is based on the comparison.

17. The one or more non-transitory computer-readable storage media according to claim 12, the operations further comprising:
determining a third set of encryption keys associated with the set of encryption layers based on a combination of the set of encryption keys associated with each of the set of encryption layers, wherein
the generation of the first set of encryption keys associated with the set of encryption layers for the first digest is based on the third set of encryption keys.

18. The one or more non-transitory computer-readable storage media according to claim 12, further comprising:
determining an event type of the first event log based on the generation of the set of encryption keys associated with the set of encryption layers for the first digest, wherein
the first event information is pre-sorted based on the event type.

19. The one or more non-transitory computer-readable storage media according to claim 18, wherein the event type of the first event log is at least one of:
a successful authentication attempt event type,
a failed authentication attempt event type,
a file accesses event type,
a data access event type,
a security policy change event type,
an account change event type,
an identity change event type,
a privilege usage event type, or
an actor identification event type.

20. An electronic device, comprising:
a memory configured to store instructions; and
a processor, coupled to the memory, configured to execute the instructions to perform a process comprising:
detecting a first event log associated with a first network component of an open-radio access network (O-RAN);
generating a first digest associated with the first event log;
generating each encryption key of a first set of encryption keys, based on an encryption layer of a set of encryption layers, and the first event log;
generate a first set of encrypted digests for the first digest, based on the first set of encryption keys;
generating first log information associated with the first network component, based on the first event log and the first set of encrypted digests;
transmitting the first log information to a service management component of the O-RAN,
the service management component is configured to pre-sort the first log information, based on the first set of encrypted digests; and
controlling a first display device to render the first log information.
